(19) United States
(12) Patent Application Publication
(10) Pub. No.: US 2008/0284765 A1
(43) Pub. Date: Nov. 20, 2008

(54) Plasma display device and signal transmitting unit for plasma display device

(76) Inventor: Ulje Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/153,213

(22) Filed: May 15, 2008

(30) Foreign Application Priority Data
May 15, 2007 (KR) 10-2007-0047143

(51) Int. Cl. G09G 3/28

(52) U.S. Cl. 345/206

(57) ABSTRACT

A plasma display device includes a plasma display panel, a chassis base on the plasma display panel, a driving circuit portion on the plasma display panel, and a signal transmitting unit electrically connecting the plasma display panel to the driving circuit portion, the signal transmitting unit including, a film having first and second surfaces, a driving integrated circuit (IC) on the first surface of the film, a gap pad including a first gap pad portion on the first surface of the film and a second gap pad portion on the second surface of the film, the driving IC being positioned between the first gap pad portion and the first surface of the film, and at least one transmission opening in at least one of the first and second surfaces of the film, a portion of the gap pad being in the transmission opening.

### BACKGROUND OF THE INVENTION

1. Field of the Invention

Embodiments of the present invention relate to a plasma display device. More particularly, embodiments of the present invention relate to a plasma display device capable of effectively dissipating heat generated by a driving IC of a signal transmitting unit of a plasma display panel.

2. Description of the Related Art

Plasma display devices may refer to flat display devices displaying images via a plasma discharge phenomenon. A conventional plasma display device may include a plasma display panel (PDP), a plurality of intersecting electrodes, a plurality of discharge cells at intersection points of the electrodes, and photoluminescent material in the discharge cells. The grayscales of pixels may be displayed by adjusting discharging states of the discharge cells via voltage applied to the electrodes through driving circuits. Application of voltage to the discharge cells may generate plasma in the discharge cells, so light may be emitted from the photoluminescent material in the discharge cells to form images.

However, application of voltage to the discharge cells may require large power consumption by the driving circuits, so a large amount of heat may be emitted in the PDP, thereby increasing an overall temperature of the PDP. An increase of temperature in the PDP may deteriorate, e.g., the photoluminescent material in the discharge cells, thereby decreasing brightness and lifespan of the PDP. In addition, the increase of temperature in the PDP may cause thermal expansion of, e.g., a glass PDP, thereby generating stress and damaging the PDP. Further, the increase of temperature in the PDP may overheat the driving circuits, thereby causing erroneous operation of thereof. For example, a driving integrated circuit (IC) of a tape carrier package (TCP) may generate a large amount of heat, and may have no separate heat sink, thereby causing erroneous operation of the driving IC. An erroneous operation of the driving circuits may cause faulty discharge, e.g., discharge in incorrect discharge cells, thereby reducing a display quality of the PDP.

### SUMMARY OF THE INVENTION

Embodiments of the present invention are therefore directed to a plasma display device, which substantially overcomes one or more of the disadvantages of the related art.

It is therefore a feature of an embodiment of the present invention to provide a signal transmitting unit with a structure providing improved thermal conductivity.

It is therefore another feature of an embodiment of the present invention to provide a plasma display device with a signal transmitting unit having improved heat dissipation capabilities.

At least one of the above and other features and advantages of the present invention may be realized by providing a plasma display device, including a plasma display panel, a chassis base on the plasma display panel, a driving circuit portion on the plasma display panel, and a signal transmitting unit electrically connecting the plasma display panel to the driving circuit portion, the signal transmitting unit having a film having first and second surfaces, a driving integrated circuit (IC) on the first surface of the film, a gap pad including a first gap pad portion on the first surface of the film and a second gap pad portion on the second surface of the film, the driving IC being positioned between the first gap pad portion and the first surface of the film, and at least one transmission opening in at least one of the first and second surfaces of the film, a portion of the gap pad being in the transmission opening.

The transmission openings may be transmission grooves. The signal transmitting unit may include a plurality of transmission grooves in the first surface of the film, portions of the first gap pad portion being in the plurality of transmission grooves. The transmission grooves may be adjacent to at least two sides of the driving IC. The transmission groove may have a frame-shape and surrounds the driving IC.

The transmission openings may be transmission holes. The signal transmitting unit may include a plurality of transmission holes in the first surface of the film, portions of the first gap pad portion being in the plurality of transmission holes. The transmission holes may be adjacent to at least two sides of the driving IC. The transmission hole may have a frame-shape and surrounds the driving IC. The transmission hole may be configured to expose signal lines in the film of the signal transmitting unit.

The gap pad may be a heat sink including a material exhibiting flexibility and thermal conductivity. The signal transmitting unit may be a tape carrier package (TCP) type. The driving circuit portion may be a logic buffer board. The film of the signal transmitting unit may include a first layer configured to define the first surface of the film and a second layer configured to define the second surface of the film, the first layer including signal lines to electrically connect the plasma display panel to the driving circuit portion. The film may further include a mold between the signal lines and the driving IC.

The driving circuit portion may be on the chassis base. The chassis base may include a bent portion, and the driving IC may be on a portion of the signal transmitting unit overlapping with the bent portion of the chassis base. The chassis base may include a through hole, and the driving circuit portion may be in the through hole and directly on the plasma display panel. A portion of the signal transmitting unit may be in the through hole of the chassis base.

At least one of the above and other features and advantages of the present invention may be also realized by providing a signal transmitting unit for a plasma display device, including a film having first and second surfaces, the film including signal lines, a driving integrated circuit (IC) on the first surface of the film, a gap pad including a first gap pad portion on the first surface of the film and a second gap pad portion on the second surface of the film, the driving IC being positioned between the first gap pad portion and the first surface of the film, and at least one transmission opening in at least one of the first and second surfaces of the film, a portion of the gap pad being in the transmission opening.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a plasma display device according to an exemplary embodiment of the present invention;

FIG. 2 illustrates a partial cross-sectional view of an assembled plasma display device of FIG. 1 along line I-I′;

FIG. 3 illustrates an enlarged cross-sectional view of portion “A” of FIG. 2;

FIG. 4 illustrates a plan view of a contact area of a signal transmitting unit of FIG. 3;

FIG. 5 illustrates a plan view of a contact area of a signal transmitting unit according to another exemplary embodiment of the present invention;

FIG. 6 illustrates an enlarged cross-sectional view of a portion of a plasma display device corresponding to portion “A” of FIG. 2 according to another exemplary embodiment of the present invention;

FIG. 7 illustrates an exploded perspective view of a plasma display device according to another exemplary embodiment of the present invention;

FIG. 8 illustrates a partial cross-sectional view of an assembled plasma display device of FIG. 7 along line II-II′;

FIG. 9 illustrates an enlarged cross-sectional view of portion “B” of FIG. 8; and

FIG. 10 illustrates an enlarged cross-sectional view of a portion of a plasma display device corresponding to portion “B” of FIG. 8 according to another exemplary embodiment of the present invention.

### DETAILED DESCRIPTION OF THE INVENTION

Korean Patent Application No. 10-2007-0047143, filed on May 15, 2007, in the Korean Intellectual Property Office, and entitled: “Plasma Display Device,” is incorporated by reference herein in its entirety.

Embodiments of the present invention will be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, or one or more intervening layers may also be present. In addition, it will also be understood that when a layer is referred to as being “between” two layers, it can be the only layer between the two layers, or one or more intervening layers may also be present. Like reference numerals refer to like elements throughout.

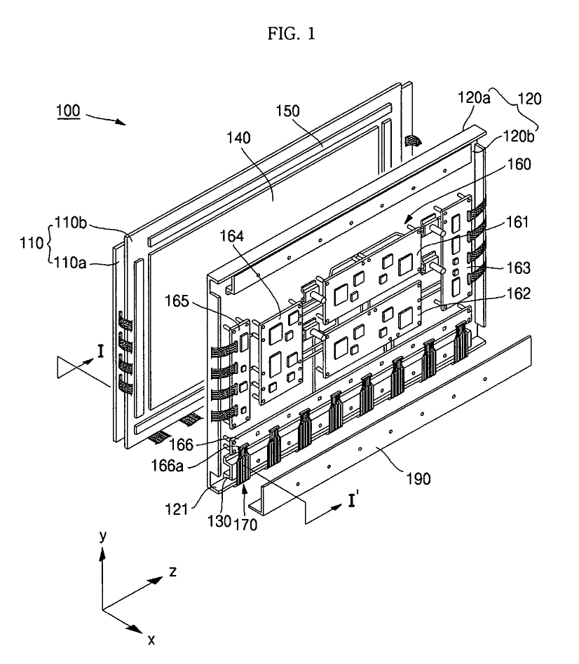

A plasma display device according to an exemplary embodiment of the present invention is described hereinafter with reference to FIGS. 1-4.

Referring to FIG. 1, a plasma display device 100 may include a plasma display panel (PDP) 110, a chassis base 120, at least one reinforcing member 130, at least one heat conduction sheet 140, at least one adhesive member 150, a driving circuit portion 160, at least one signal transmitting unit 170 with a gap pad 180, and a cover plate 190.

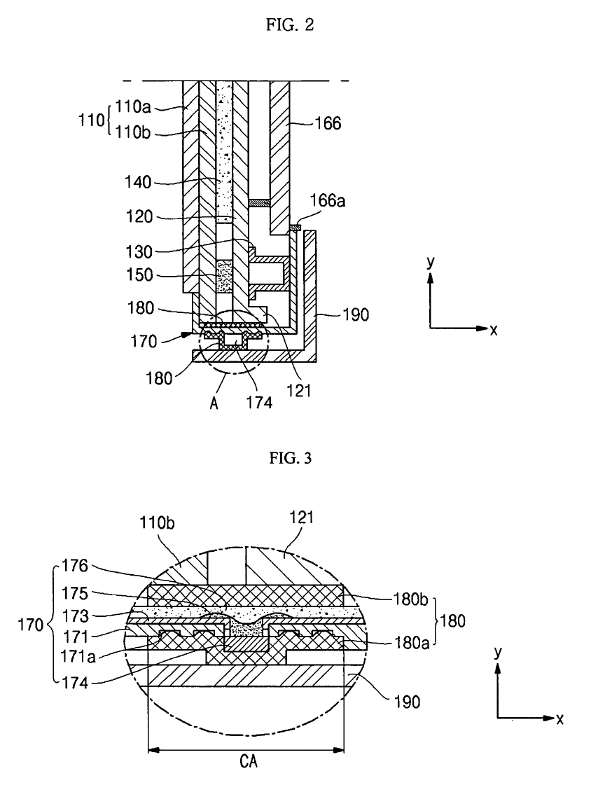

As illustrated in FIG. 1, the PDP 110 may include a front panel 110a and a rear panel 110b facing each other, and may display characters and/or images by gas discharge phenomenon. The front panel 110a may include display electrodes (not shown) along a first direction, e.g., along a horizontal axis, and the rear panel 110b may include address electrodes (not shown) along a second direction, e.g., along a vertical axis. The display and address electrodes may have any suitable structure, e.g., linear electrodes parallel to one another. The display and address electrodes may face each other, and may intersect one another. Discharge cells may be formed at intersection points of the display and address electrodes. The PDP 110 may further include photoluminescent material, e.g., phosphor layers, in the discharge cells, and, e.g., one or more of barrier ribs, dielectric layer, and/or a protective film between the front panel 110a and the rear panel 110b. The discharge cells may be filled with an inert gas, so that upon discharge therein, ultraviolet (UV) light may be generated at a predetermined wavelength to excite the photoluminescent material in the discharge cells. The PDP 110 may be connected to the driving circuit portion 160 through the signal transmitting unit 170, as will be described in more detail below with reference to FIGS. 2-4. In this respect, it is noted that the term “front” refers to a direction pointing from the chassis base 120 toward the front panel 110a, and the term “rear” refers to a direction pointing from the front panel 110a toward the chassis base 120.

The chassis base 120 of the plasma display device 100 may include front and rear surfaces 120a and 120b, and may be attached to the PDP 110. More specifically, as illustrated in FIG. 1, the front surface 120a of the chassis base 120 may be attached to the rear panel 110b of the PDP 110, thereby supporting the PDP 110 and dissipating heat generated therein. The chassis base 120 may further include a bent portion 121 extending along an edge of the chassis base 120 and protruding away from the PDP 110. In other words, the bent potion 121 may extend in a plane, e.g., the xz-plane, perpendicular to a plane of the rear surface 120b, e.g., the yz-plane, to increase strength of the chassis base 120. The chassis base 120 may be formed of any suitable material, e.g., a material having high thermal conductivity, such as aluminum.

As illustrated in FIG. 1, the reinforcing member 130 of the plasma display device 100 may extend along the rear surface 120b of the chassis base 120, e.g., along the z-axis, to prevent the chassis base 120 from being bent or deformed. The reinforcing member 130 may be formed of a metallic material having a high strength and thermal conductivity, e.g., aluminum. The reinforcing member 130 may be formed integrally with the chassis base 120. Alternatively, the reinforcing member 130 may be manufactured as a separate unit, and may be affixed to the rear surface 120b of the chassis base 120, e.g., by screws. The reinforcing member 130 may be in contact with the signal transmitting unit 170 to provide a heat sink for heat generated by the signal transmitting unit 170.

The heat conduction sheet 140 of the plasma display device 100 may be provided between the PDP 110 and the chassis base 120, as illustrated in FIG. 1, to transmit and/or dissipate heat generated by the PDP 110. For example, heat generated during driving of the plasma display device in the PDP 110 may be transmitted to the chassis base 120 via the heat conduction sheet 140, thereby minimizing sudden temperature increases of the PDP 110. In addition, the heat conduction sheet 140 may provide uniform temperature distribution in the PDP 110 in order to minimize damage and/or erroneous operation of the PDP 110. The heat conduction sheet 140 may be attached to the chassis base 120 by any suitable method, e.g., the attachment may depend on the material of the chassis base 120 in order to provide proper operation of the PDP 110. The heat conduction sheet 140 may be formed of a material having thermal conductivity, e.g., thermal grease.

The adhesive member 150 of the plasma display device 100 may have any suitable shape, e.g., a strip shape or a frame shape, and may be formed on peripheral portions of the rear panel 110b of the PDP 110, as illustrated in FIG. 1. For example, the adhesive member 150 may be formed around the heat conduction sheet 140, as illustrated in FIG. 1, to facilitate attachment of the PDP 110 to the chassis base 120. The adhesive member 150 may be an adhesive, an adhesive sheet, and/or an adhesive tape. An attachment method, thickness, and shape of the adhesive member 150 may be adjusted with respect to properties of the chassis base 120, e.g., material, shape, and so forth.

The driving circuit portion 160 of the plasma display device 100 may be on the rear panel 110b of the PDP 110. More specifically, the driving circuit portion 160 may be affixed to the rear surface 120b of the chassis base 120 by connection members, and may include a plurality of driving boards 161, 162, 163, 164, 165, 166 to drive the PDP 110. That is, the driving circuit portion 160 may include a switch mode power supply (hereinafter, referred to as SMPS) 161, a logic board 162, a sustain driving board 163, a scan driving board 164, a scan buffer board 165, and a logic buffer board 166. Each one of driving boards 161, 162, 163, 164, 165, 166 may include circuit elements and a driving integrated circuit (IC) for driving the PDP 110.

The SMPS 161 may supply power to, e.g., the driving boards 162, 163, 164, 165, 166, and may include an AC/DC converter for converting an external AC voltage into DC voltage. The logic board 162 may receive image signals, and may separate and control the received image signals by type, i.e., signals to be transmitted to the sustain driving board 163, scan driving board 164, or logic buffer board 166. The logic board 162 may automatically control power. The sustain driving board 163, the scan driving board 164, and the logic buffer board 166 may receive respective signals from the logic board 162, and may transmit the received signals through respective driving ICs to the electrodes. The scan buffer board 165 may be provided between the scan driving board 164 and the PDP 110, and may transmit driving signals from the scan driving board 164 to the PDP 110.

The signal transmitting unit 170 of the plasma display device 100 may electrically connect the driving circuit portion 160, i.e., one or more of the sustain driving board 163, scan buffer board 165, and/or logic buffer board 166, to the PDP 110, and may transmit driving signals from the driving circuit portion 160 to the PDP 110. Accordingly, the signal transmitting unit 170 may be bent around edges of the PDP 110 and chassis base 120, so a first end of the signal transmitting unit 170 may be attached to the PDP 110 and a second end of the signal transmitting unit 170 may be attached to a respective driving board 163, 165, 166 on the rear surface 120b of the chassis base 120. The signal transmitting unit 170 may be, e.g., a flexible printed circuit board (FPCB), a tape carrier package (TCP), or a chip on film (COF).

For example, the signal transmitting unit 170 may be a TCP or a COF with a driving IC, and may connect the logic buffer board 166, i.e., a board buffering data for displaying an image, to the PDP 110, as illustrated in FIG. 2. In particular, as further illustrated in FIG. 2, the signal transmitting unit 170 may be placed across the bent portion 121 of the chassis base 120, such that the first end of the signal transmitting unit 170 may be connected to the PDP 110 via an electrode (not shown) and the second end of the signal transmitting unit 170 may be connected to a connector 166a of the logic buffer board 166. The signal transmitting unit 170 may include a middle portion between the first and second ends, so the middle portion is substantially parallel to the bent portion 121 of the chassis base 120. A driving IC 174 may be mounted on the middle portion of the signal transmitting unit 170, i.e., at a position corresponding to and substantially overlapping with a portion of the bent portion 121 of the chassis base 120, as illustrated in portion A of FIG. 2. It is noted that other configurations of the driving IC 174 of the signal transmitting unit 170, e.g., the driving IC 174 may be mounted on a portion of the signal transmitting unit 170 corresponding to and substantially overlapping with the reinforcing member 130, are within the scope of the present invention.

More particularly, as illustrated in FIG. 3, the signal transmitting unit 170 may include a multi-layered film, e.g., a base film 171 and a protective film 176, the driving IC 174 on a first surface of the base film 171, and a mold 175 on a second surface of the base film 171. The protective film 176 may be on the second surface of the base film 171. The second surface of the base film 171 may be opposite the first surface of the base film 171.

The base film 171 of the signal transmitting unit 170 may be formed of an insulating material, e.g., polyimide (PI), and may extend from the PDP 110 to the logic buffer board 166. The base film 171 may include signal lines 173 for electrically connecting the electrodes of the PDP 110 to the connectors 166a of the logic buffer board 166. As further illustrated in FIG. 3, the signal lines 173 may be disposed in an upper portion of the base film 171, i.e., a portion including the second surface of the base film 171, so the signal lines 173 may be between the first and second surfaces of the base film 171. The first surface of the base film 171 may define at least a portion of a first surface of the signal transmitting unit 170.

The driving IC 174 of the signal transmitting unit 170 may correspond to the first surface of the base film 171, and may be external to the base film 171. In other words, as illustrated in FIG. 3, the driving IC 174 may be attached to the first surface of the base film 171, so the driving IC 174 may be between the first surface of the base film 171 and a first gap pad 180a. The driving IC 174 may be electrically connected to the signal lines 173 of the base film 171 by, e.g., wire bonding or tab bonding. Connection portions between the signal lines 173 and the driving IC 174, as illustrated in FIG. 3, may be molded with the mold 175. The mold 175 may be any suitable material, e.g., an insulting material, and may be applied to be in contact with the second surface of the base film 171, i.e., signal lines 173, and with the driving IC 174.

The protective film 176 of the signal transmitting unit 170 may be formed of an insulating material, e.g., PI, and may define at least a portion of a second surface of the signal transmitting unit 170. The protective film 176 may be formed on the signal lines 173 of the base film 171 and on the mold 175 to provide protection thereto. The protective film 176 may extend along the base film 171, so the protective film 176 may partially or completely overlap the base film 171.

The signal transmitting unit 170 may further include at least one transmission opening, i.e., a recess having a predetermined shape and thickness, in at least one of the first and/or second surfaces of the signal transmitting unit 170. For example, as illustrated in FIG. 3, the transmission opening may be a transmission groove 171a. In this respect, it is noted that a “groove” may refer to a recess having a relatively low thickness as measured along the y-axis, so a thin layer portion of the base film 171 may remain between the transmission groove 171a and the signal lines 173. The thickness of the groove 171a may be measured from the first surface of the base film 171 in an upward direction along the y-axis. The transmission groove 171a may have any suitable shape, e.g., a rectangular cross-section in the xy-plane.

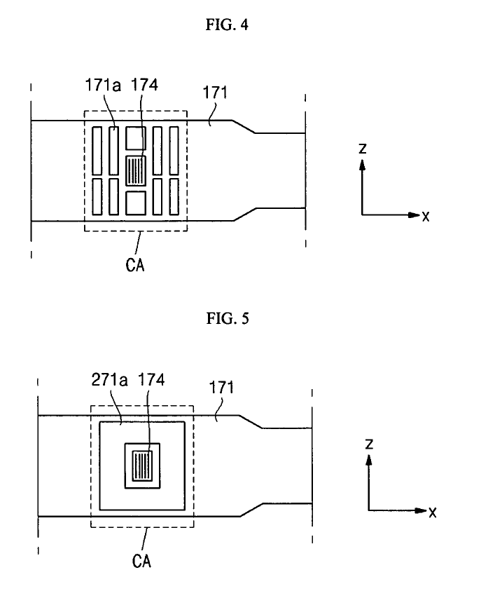

The transmission groove 171a may be formed in at least one of the first and/or second surfaces of the signal transmitting unit 170. For example, as further illustrated in FIG. 3, the transmission grooves 171a may be formed in the first surface of the base film 171, so a portion of the base film 171 having the transmission grooves 171a may be thinner than a portion of the base film 171 having no transmission grooves 171a. The transmission grooves 171a may be formed adjacent to the driving IC 174, so a portion of base film 171 adjacent to the driving IC 174 may be thinner than other portions of the base film 171. For example, one or more transmission grooves 171a may be formed immediately adjacent to each side of the driving IC 174 along the x-axis, as illustrated in FIGS. 3-4. The transmission groove 171a may not overlap with the driving IC 174.

The transmission groove 171a may have any suitable shape. For example, as illustrated in FIG. 4, the signal transmitting unit 170 may include a plurality of longitudinal grooves 171a arranged in a stripe-pattern and adjacent to the driving IC 174. Alternatively, as illustrated in FIG. 5, the plasma display device 100 may include a single transmission groove 271a instead of the plurality of transmission grooves 171a. The single transmission groove 271a may be integrally formed in the base film 171, and may have a frame-shape. That is, the transmission groove 271a may be a recess surrounding the driving IC 174 in the xz-plane. The transmission groves 171a and 271a may be formed in a contact area CA, i.e., a contact region between the gap pad 180 and the signal transmitting unit 170.

The gap pad 180 of the plasma display device 100 may include a first gap pad 180a along the first surface of the signal transmitting unit 170 and a second gap pad 180b along the second surface of the signal transmitting unit 170, as illustrated in FIG. 3. More specifically, the first gap pad 180a may be applied to correspond to and overlap with the first surface of the signal transmitting unit 170, so the first gap pad 180a may be closely adhered between the first surface of the signal transmitting unit 170 and the cover plate 190, as illustrated in FIGS. 2-3. The first gap 180a may enclose the driving IC 174. For example, the first gap pad 180a may be applied to the base film 171 to completely enclose at least three surfaces of the driving IC 174. The second gap pad 180b may be positioned in parallel to the middle portion of the signal transmission unit 170 and on a second surface thereof, so the second gap pad 180b may be closely adhered between the second surface of the signal transmitting unit 170 and the bent portion 121 of the chassis base 120. The gap pad 180 may be formed of a material having thermal conductivity and flexibility, e.g., silicon and/or thermal grease.

The gap pad 180 may transmit heat generated by the signal transmitting unit 170, e.g., heat generated by the driving IC 174 during driving of the PDP 110, to the chassis base 120 or the cover plate 190. Therefore, the gap pad 180 may prevent or substantially minimize deterioration of the driving IC 174, i.e., deterioration due to generation of large amounts of heat during driving of the PDP 110. In addition, the first gap pad 180a of the gap pad 180 may protect the driving IC 174 from an external impact. Detailed description of a connection between the gap pad 180 and the signal transmitting unit 170 is discussed in more detail below with respect to FIGS. 3-4.

As illustrated in FIGS. 3-4, the plurality of transmission grooves 171a may be formed in the contact area CA. In this respect, it is noted that the contact area CA may be a region of a complete overlap of the gap pad 180 with the signal transmitting unit 170, with the exception of the driving IC 174. In other words, the contact area CA may include a direct contact region between the gap pad 180 and first surface of the base film 171 and/or a direct contact region between the gap pad 180 and the protective film 176. Accordingly, the first gap pad 180a may be applied to the first surface of the base film 171, so a portion of the first gap pad 180a may be inserted in the transmission grooves 171a, as illustrated in FIG. 3.

Application of the first gap pad 180a to the base film 171 via the transmission grooves 171a may be advantageous in facilitating close adherence therebetween. That is, formation of the grooves 171a in the base film 171 in an area adjacent to each side of the driving IC 174 may facilitate insertion of portions of the first gap pad 180a in the transmission grooves 171a surrounding the driving IC 174, thereby increasing adhesion between the base film 171 and the first gap pad 180a, e.g., due to increased contact area therebetween. An improved adhesion of the first gap pad 180a to the base film 171 with the driving IC 174 therebetween may be further advantageous in providing improved protection to the driving IC 174.

Further, the increased adhesion between the base film 171 and the first gap pad 180a and the increased contact area therebetween may be advantageous in facilitating heat dissipation. That is, the transmission grooves 171a may reduce thickness of the base film 171 in the contact area CA, thereby increasing transmission of heat generated in the driving IC 174 through the base film 171 to the first gap pad 180a. In particular, heat generated in an area surrounding the connection portions between the driving IC 174 and the signal lines 173 during driving of the plasma PDP 110 may be dissipated through the transmission grooves 171a of the base film 171 at an increased speed, as compared, e.g., to a plasma display device having no transmission grooves or having a thick signal transmitting unit.

Therefore, thermal conductivity from the signal transmitting unit 170 to the first gap pad 180a may be improved, thereby enhancing efficiency of heat dissipation from the driving IC 174 to the cover plate 190 through the signal transmitting unit 170 and the first gap pad 180a. In addition, thermal conductivity from the second gap pad 180b to the first gap pad 180a, e.g., via the signal transmitting unit 170, may be improved, thereby facilitating an overall enhanced efficiency of heat dissipation from the PDP 110 to the cover plate 190 via the signal transmitting unit 170 in addition to heat dissipation through the chassis base 120. If the plasma display device 100 includes the transmission groove 271a illustrated in FIG. 5, the contact area CA may be larger than the contact area CA in FIGS. 3-4, thereby further increasing efficiency of heat dissipation.

It is noted that the transmission grooves 171a and 271a may have other configurations. For example, the transmission grooves 171a and/or 271a may be formed in the protective film 176, thereby improving thermal conductivity between the signal transmitting unit 170 and the chassis base 120, which in turn, may enhance effective heat dissipation from the driving IC 174 or the PDP 110.

The cover plate 190 of the plasma display device 100 may be attached to the bent portion 121 of the chassis base 120 or to the reinforcing member 130 by, e.g., a connection member, so the signal transmitting unit 170 may be between the cover plate 190 and, e.g., the chassis base 120. The cover plate 190 may be formed of a metallic material having a predetermined strength and thermal conductivity, e.g., aluminum. The cover plate 190 may protect the driving IC 174 from an external impact, and may dissipate heat generated by the driving IC 174 and transmitted through the gap pad 180. The cover plate 190 may be in contact with the gap pad 180 in order to improve efficiency of heat dissipation. For example, as illustrated in FIGS. 2-3, the cover plate 190 may be attached to the first gap pad 180a, so the first gap pad 180a may be between the cover plate 190 and the driving IC 174.

As described above, the plasma display device 100 according to embodiments of the present invention may be advantageous in including at least one transmission groove 171a or 271a in the contact area CA in at least one of the two surfaces of the signal transmitting unit 170. Formation of the transmission groove 171a or 271a may reduce the thickness of the protective film 176 and/or the base film 171 in a region adjacent to the driving IC 174, thereby improving thermal conductivity between the gap pad 180 and the signal transmitting unit 170. Thus, heat dissipation of heat generated by the driving IC 174 of the signal transmitting unit 170 may be improved, thereby preventing or substantially minimizing erroneous operations of circuits in the plasma display device 100.

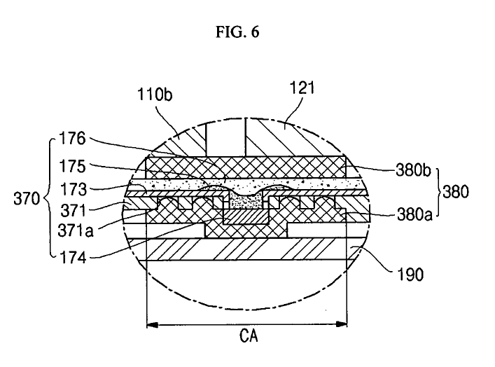

According to another embodiment illustrated in FIG. 6, a plasma display device may be substantially similar to the plasma display device 100 described previously with reference to FIGS. 1-4, with the exception of having a signal transmitting unit 370 instead of the signal transmitting unit 170. The signal transmitting unit 370 may be substantially similar to the signal transmitting unit 170, with the exception of having a plurality of transmission holes 371a, instead of the plurality of transmission grooves 171a. Only the plurality of transmission holes 371a will be explained in detail, since other components of the plasma display device of FIG. 6 may be substantially similar to the components of the plasma display device 100 described previously with reference to FIGS. 1-4.

The signal transmitting unit 370 may include at least one transmission hole 371a in the contact area CA. In this respect, it is noted that a “hole” may be a recess having a higher thickness than a groove as measured along the y-axis, e.g., a through-hole. For example, as illustrated in FIG. 6, the transmission holes 371a may have sufficient thickness along the y-axis to expose the signal lines 173, i.e., be in direct contact with the signal lines 173. The transmission hole 371a may have any suitable shape, e.g., a rectangular, circular, or oval cross-section in the xy-plane.

The transmission holes 371a may be formed in any suitable position in the contact region CA, and may be in direct contact with a gap pad 380. For example, the transmission hole 371a may be formed in the first surface of the base film 171, in the protective film 176, and so forth. A size of the contact area CA may be increased to enhance heat dissipation. The transmission hole 371a may not be formed in the driving IC 174.

As illustrated in FIG. 6, the transmission hole 371a may be formed in the contact area CA by removing portions of, e.g., the base film 171, to expose the signal line 173. The transmission holes 371a may be formed adjacent to the driving IC 174, and may facilitate contact between the base film 171 and a first gap pad 380a. Accordingly, when the cover plate 190 is attached to the first gap pad 380a, portions of the first gap pad 380a may be inserted into the transmission holes 371a, thereby closely adhering the first gap pad 380a to the exposed signal lines 173 through the transmission holes 370a. The gap pad 380 may be formed of a material having thermal conductivity, flexibility, and an insulating property in order to provide electrical insulation with respect to the exposed signal lines 173. For example, the gap pad 380 may be a heat sink formed by coating a silicon material or a thermal grease material with an insulating material.

The transmission holes 371a may facilitate dissipation of heat generated during driving of the PDP 110. That is, heat generated by the driving IC 174, e.g., heat generated in the connection portions of the driving IC 174 and the signal lines 173, may be transmitted directly from the signal lines 173 to the first gap pad 380a. Therefore, thermal conductivity between the signal transmitting unit 370 and the first gap pad 380a may be improved, thereby enhancing efficiency of heat dissipation from the driving IC 174 to the cover plate 190 through the signal transmitting unit 370 and through the first gap pad 380a. In addition, thermal conductivity between the second gap pad 380b and the cover plate 190 via the signal transmitting unit 370 may be improved, thereby enhancing overall effective dissipation of heat generated in the PDP 110. If the transmission hole 371a is formed in the protective film 176, thermal conductivity between the signal transmitting unit 370 and the chassis base 120 may be improved, thereby increasing efficiency of heat dissipation from the driving IC 174.

As described above, the plasma display device formed according to an embodiment illustrated in FIG. 6 may have substantially similar advantages to the advantages of the plasma display device 100. In addition, the plasma display device formed according to the embodiment illustrated in FIG. 6 may be advantageous in providing transmission holes 371a exposing signal lines 173, so portions of the gap pad 380 may be in contact with the signal transmitting unit 370 therethrough. The transmission holes 371a may facilitate heat dissipation from the signal lines 173, and may improve overall thermal conductivity between the gap pad 380 and the signal transmitting unit 370.

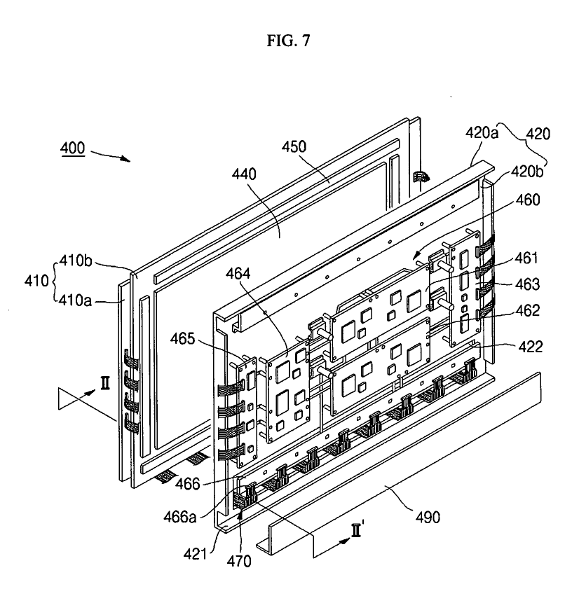

According to another embodiment illustrated in FIGS. 7-9, a plasma display device 400 may be substantially similar to the plasma display device 100 described previously with reference to FIGS. 1-4, with the exception of having a through hole in a chassis base to facilitate mounting of a logic buffer board on a PDP. In particular, as illustrated FIGS. 7-9, the plasma display device 400 may include a PDP 410, a chassis base 420, a heat conduction sheet 440, an adhesive member 450, a driving circuit portion 460 including a logic buffer board 466, a signal transmitting unit 470, a gap pad 480, and a cover plate 490. The PDP 410, heat conduction sheet 440, and adhesive member 450 may be substantially similar to the PDP 110, heat conduction sheet 140, and adhesive member 150 of the plasma display device 100, respectively, and thus, their detailed description will not be repeated.

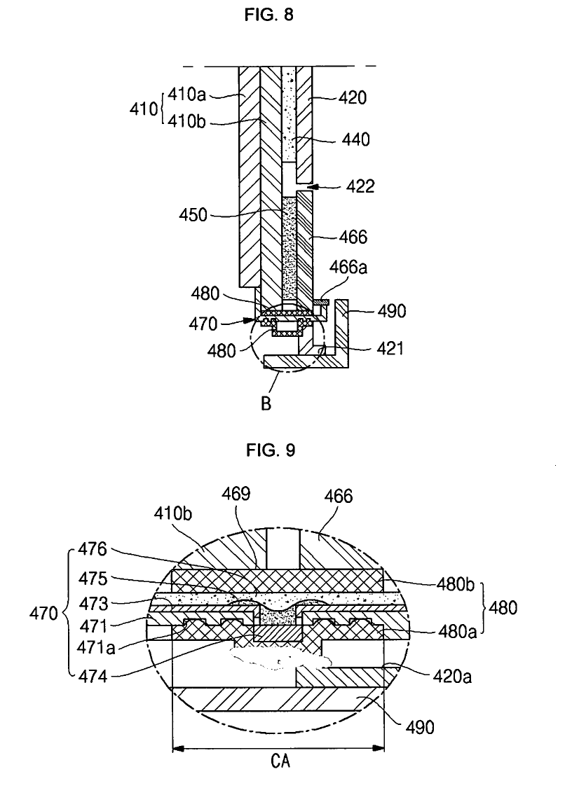

The chassis base 420 of the plasma display device 400 may be substantially similar to the chassis base 120 of the plasma display device 100, with the exception of having a through hole 422 therein. In particular, as illustrated in FIGS. 7-8, the through hole 422 may have any suitable shape, e.g., rectangular, and may extend at any suitable location of the chassis base 420 along an edge thereof to facilitate mounting a logic buffer board 466 therein. The through hole 422 may be formed along only one edge of the chassis base 420 in order to, e.g., avoid excessive reduction of a size of the chassis base 420, so support of the PDP 410 by the chassis base 420 may not be minimized. For example, as illustrated in FIGS. 7-8, the through hole 422 may be formed in a lower portion of the chassis base 420, e.g., above and in parallel to a bent portion 421 of the chassis base 420. Other configurations of the through hole 422, e.g., a through hole 422 in a lower portion of the chassis base 420 without the bent portion 421, a through hole 422 in an upper portion of the chassis base, and so forth, are within the scope of the present invention.

The driving circuit portion 460 of the plasma display device 400 may include a SMPS 461, a logic board 462, a sustain driving board 463, a scan driving board 464, a scan buffer board 465, and the logic buffer board 466. The driving circuit portion 460 may be substantially similar to the driving circuit portion 160 of the plasma display device 100, with the exception of having a different position of the logic buffer board 466. That is, the SMPS 461, logic board 462, sustain driving board 463, scan driving board 464, and scan buffer board 465 may include heavy elements, e.g., an energy recovery circuit (ERC), a power circuit element, and so forth, and may be mounted on a rear surface 420b of the chassis base 420. The logic buffer board 466 may include substantially lighter elements, e.g., an Intelligent Power Module (IPM), a timing controller, signal input terminals, a circuit that buffers data for displaying images, and may be supported directly by the PDP 410. That is, the logic buffer board 466 may be inserted through the through hole 422 of the chassis base 420 to be mounted directly on a rear panel 410b of the PDP 410. The logic buffer board 466 may be adhered to the rear panel 410b by a connection member or an adhesion member, e.g., a double-sided tape.

Mounting the logic buffer board 466 directly on the PDP 410 through the through hole 422 of the chassis base 420 may be advantageous in decreasing a distance between the PDP 410 and the logic buffer board 466. The decreased distance between the PDP 410 and logic buffer board 466 may reduce a required length of the signal transmitting unit 470 electrically connecting the logic buffer board 466 and the PDP 410, thereby reducing manufacturing costs of a TCP-type signal transmitting unit.

The signal transmitting unit 470 of the plasma display device 400 may be disposed to connect the logic buffer board 466 to the PDP 410 through the through hole 422. More particularly, a first end of the signal transmitting unit 470 may be connected to an electrode (not shown) of the PDP 410, and a second end of the signal transmitting unit 470 may be connected to a connector 466a of the logic buffer board 466. The second end of the signal transmitting unit 470 may be inserted through the through hole 422 to be attached to the connector 466, so the bent portion 421 of the chassis base 420 may be below the signal transmitting unit 470. The signal transmitting unit 470 may include a middle portion between the first and second ends thereof, so the middle portion may be substantially parallel to the bent portion 421 of the chassis base 420. The middle portion of the signal transmitting unit 470 may be mounted on a horizontal plane 469 connecting the rear panel 410b and the logic buffer board 466, as illustrated in FIG. 9.

The signal transmitting unit 470 may include a base film 471, the driving IC 474 corresponding to a first surface of the base film 471, a mold 475 corresponding to a second surface of the base film 471, a protective film 476 corresponding to the second surface of the base film 471, and transmission grooves 471a. The elements of the signal transmitting unit 470 may be substantially similar to the elements of the signal transmitting unit 170 of the plasma display device 100, and therefore, their detailed description will not be repeated.

The gap pad 480 of the plasma display device 400 may include first and second gap pads 480a and 480b. The first and second gap pads 480a and 480b may be substantially similar to the first and second gap pads 180a and 180b of the plasma display device 100, respectively, with the exception of being in direct contact with the chassis base 420. In particular, the first gap pad 480a may be formed along one surface of the signal transmitting unit 470 to cover the driving IC 474 as described previously with respect to the first gap pad 180a of the plasma display device 100, and may be in direct contact with the chassis base 420 through the hole through 422. That is, a portion of a lower surface of the first gap pad 480a, i.e., a surface facing away from the signal transmitting unit 470, may be in contact with the chassis base 420. The second gap pad 480b may be formed between the horizontal surface 469 and the signal transmitting unit 470, and may be in direct contact with the logic buffer board 466 through the hole through 422. The gap pad 480 may enhance dissipation of heat generated by the signal transmitting unit 470, thereby minimizing deterioration of the driving IC 474. The gap pad 480 may be formed of a material having thermal conductivity and flexibility, e.g., silicon and/or thermal grease. In addition, the first gap pad 480a may protect the driving IC 474 from an external impact.

The cover plate 490 of the plasma display device 400 may be coupled to the bent portion 421 of the chassis base 420 by a separate connection member, so the bent portion 421 may be between the cover plate 490 and the signal transmitting unit 470. The cover plate 490 and the gap pad 480 may protect the driving IC 474 from an external impact, and the cover plate 490 may dissipate heat generated by the driving IC 474 via the gap pad 480 and the bent portion 421 of the chassis base 420 to the outside.

As illustrated in FIGS. 8-9, the transmission grooves 471a of the signal transmitting unit 470 may reduce thickness of the base film 471 in areas adjacent to the driving IC 474, so heat generated in the driving IC 474 during the driving of the plasma display device 400 may be dissipated at an increased rate through the first gap pad 480a and the bent portion 421 of the chassis base 420 to the cover plate 490. Therefore, thermal conductivity from the signal transmitting unit 470 to the first gap pad 480a may be improved, so an overall efficiency of heat dissipation from the driving IC 474 to the cover plate 490 through the signal transmitting unit 470, the first gap pad 480a, and the bent portion 421 may be enhanced. In addition, thermal conductivity from the second gap pad 480b to the first gap pad 480a may be improved, thereby further improving heat dissipation from the PDP 410 through the cover plate 490, as well as through the chassis base 420. Further, the length of the signal transmitting unit 470 may be reduced by mounting the logic buffer board 466 directly on the PDP 410, thereby minimizing manufacturing costs of TCP and overall costs of a plasma display device.

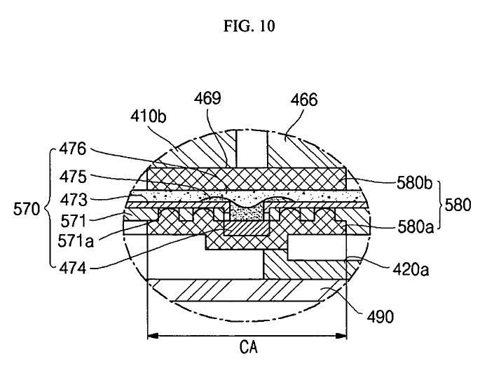

According to another embodiment illustrated in FIG. 10, a plasma display device may be substantially similar to the plasma display device 400 described previously with respect to FIGS. 7-9, with the exception of having a signal transmitting unit 570 with a base film 571 having a plurality of transmission holes 571a instead of the transmission grooves 471a. The transmission holes 571a may be substantially similar to the transmission halls 371a described previously with respect to FIG. 6, and therefore, their detailed description and advantages will not be repeated. The plasma display device in FIG. 10 may include a gap pad 580 having first and second gap pads 580a and 580b. The gap pad 580 may be substantially similar to the gap pad 380 described previously with respect to FIG. 6, and therefore, its detailed description will not be repeated.

A plasma display devices according to embodiments of the present invention may be advantageous in providing at least one transmission groove or hole in the signal transmitting unit, so the gap pad may be in contact with at least one or two surfaces of the signal transmitting unit via the transmission groove or hole. The transmission groove or hole may reduce thickness of the signal transmitting unit, so thermal conductivity from the signal transmitting unit to the gap pad may be improved. The improved thermal conductivity may facilitate heat dissipation generated by the driving IC during driving of the plasma display device, thereby preventing or substantially minimizing deterioration of the driving IC. As a result, erroneous operations of circuits due to overheating of the driving IC may be prevented or substantially minimized. Further, plasma display devices according to embodiments of the present invention may provide reduced length of the signal transmitting unit, so manufacturing costs thereof may be reduced. In particular, the logic buffer board may be mounted directly on the PDP, so a length of the signal transmitting unit electrically connecting and the PDP to the logic buffer board may be reduced due to a decreased distance therebetween.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel;
a chassis base on the plasma display panel;
a driving circuit portion on the plasma display panel; and
a signal transmitting unit electrically connecting the plasma display panel to the driving circuit portion, the signal transmitting unit including,
a film having first and second surfaces;
a driving integrated circuit (IC) on the first surface of the film;
a gap pad including a first gap pad portion on the first surface of the film and a second gap pad portion on the second surface of the film, the driving IC being positioned between the first gap pad portion and the first surface of the film; and
at least one transmission opening in at least one of the first and second surfaces of the film, a portion of the gap pad being in the transmission opening.

2. The plasma display device as claimed in claim 1, wherein the transmission openings are transmission grooves.

3. The plasma display device as claimed in claim 2, wherein the signal transmitting unit includes a plurality of transmission grooves in the first surface of the film, portions of the first gap pad portion being in the plurality of transmission grooves.

4. The plasma display device as claimed in claim 3, wherein the transmission grooves are adjacent to at least two sides of the driving IC.

5. The plasma display device as claimed in claim 2, wherein the transmission groove has a frame-shape and surrounds the driving IC.

6. The plasma display device as claimed in claim 1, wherein the transmission openings are transmission holes.

7. The plasma display device as claimed in claim 6, wherein the signal transmitting unit includes a plurality of transmission holes in the first surface of the film, portions of the first gap pad portion being in the plurality of transmission holes.

8. The plasma display device as claimed in claim 7, wherein the transmission holes are adjacent to at least two sides of the driving IC.

9. The plasma display device as claimed in claim 6, wherein the transmission hole has a frame-shape and surrounds the driving IC.

10. The plasma display device as claimed in claim 6, wherein the transmission hole is configured to expose signal lines in the film of the signal transmitting unit.

11. The plasma display device as claimed in claim 1, wherein the gap pad is a heat sink including a material exhibiting flexibility and thermal conductivity.

12. The plasma display device as claimed in claim 1, wherein the signal transmitting unit is a tape carrier package (TCP) type.

13. The plasma display device as claimed in claim 1, wherein the driving circuit portion is a logic buffer board.

14. The plasma display device as claimed in claim 1, wherein the film of the signal transmitting unit includes a first layer configured to define the first surface of the film and a second layer configured to define the second surface of the film, the first layer including signal lines to electrically connect the plasma display panel to the driving circuit portion.

15. The plasma display device as claimed in claim 14, wherein the film further comprises a mold between the signal lines and the driving IC.

16. The plasma display device as claimed in claim 1, wherein the driving circuit portion is on the chassis base.

17. The plasma display device as claimed in claim 16, wherein the chassis base includes a bent portion, and the driving IC is on a portion of the signal transmitting unit overlapping with the bent portion of the chassis base.

18. The plasma display device as claimed in claim 1, wherein the chassis base includes a through hole, and the driving circuit portion is in the through hole and directly on the plasma display panel.

19. The plasma display device as claimed in claim 18, wherein a portion of the signal transmitting unit is in the through hole of the chassis base.

20. A signal transmitting unit for a plasma display device, comprising:
a film having first and second surfaces, the film including signal lines;
a driving integrated circuit. (IC) on the first surface of the film;
a gap pad including a first gap pad portion on the first surface of the film and a second gap pad portion on the second surface of the film, the driving IC being positioned between the first gap pad portion and the first surface of the film; and
at least one transmission opening in at least one of the first and second surfaces of the film, a portion of the gap pad being in the transmission opening.
